(19) United States
(12) Patent Application Publication
(10) Pub. No.: US 2009/0172926 A1
(43) Pub. Date: Jul. 9, 2009

(54) DOG LEASH WITH INTEGRATED WASTE CARRYING ATTACHMENT

(76) Inventor: LYNN KERN, WOODWAY, WA (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 11/971,885

(22) Filed: Jan. 9, 2008

(51) Int. Cl. A44B 18/00; A01K 27/00; A01K 29/00

(52) U.S. Cl. 24/444; 24/442; 119/795; 119/161

(57) ABSTRACT

This invention provides the pet owner with a leash that has a readily accessible storage area for empty excrement collecting bags. Because of its simple design, any additional bulk added to the leash because of this invention is negligible. Consequently, the leash can be folded and stored as usual; the pet owner need not think of or care for additional gadgets attached to the leash.

Also, because of its simple design, this invention allows the pet owner to remove only the excrement collection bag needed in the ready use position. Once the excrement collecting bag has been used, it can be attached to the invention so that the excrement does not fall out of the excrement collecting bag.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Pet owners may be required by law or personal ethics, to remove excrement deposited by animals during daily walks. Pet owners typically carry grocery, newspaper or other disposable bags to collect said excrement. Once excrement is collected in said bag, the bag can be disposed of in the closest rubbish bin.

The excrement collecting bags are carried by owners in hand or pockets. It is burdensome for the pet owner to carry excrement collecting bags in hand because the pet owner is left without a free hand. Carrying excrement collecting bags in a pocket is burdensome because the pet owner will spend time pulling the bag out of his pocket and then picking up the excrement. In the meantime, the pet is ready to move on to the next tree. And, the pet owner must carry a full excrement bag to a rubbish bin with his free hand. Additionally, in colder climates, a full excrement bag, carried in hand might be put into a pocket in order to keep the hand warm. One can only imagine the problems this could cause.

Information relevant to attempts to address these problems can be found in: U.S. Pub. App. No. 20060054107 (Baker, September 04); U.S. Pub. App. No. 20030111022 (Woolley, November 02); U.S. Pat. No. 6,418,881 (Starratt, June 02); U.S. Pat. No. 6,019,067 (Carey, February 2000); U.S. Pat. No. 6,035,8089 (Fingerett, March 02); U.S. Pat. No. 6,073,590 (Polding, June 00); U.S. Pat. No. 5,727,500 (Conboy, March 98); U.S. Pat. No. 5,718,192 (Sebastian, February 98); U.S. Pat. No. 5,441,017 (Lindsay, August 95); EP-0,619,944 (Aerni, October 94); U.S. Pat. No. 5,363,809 (Roe, November 94); U.S. Pat. No. 5,184,762 (Nevitt, February 93). However, each of these references suffers from one or more of the following disadvantages:
(1) creates a leash that is bulky and not easily storable;
(2) creates the potential of having excrement fall into the invention requiring the pet owner to make direct contact with the excrement;
(3) difficult to quickly remove only one excrement collecting bag from the invention;
(4) difficult to remove an excrement collecting bag in a ready to use position.

This invention provides the pet owner with a leash that has a readily accessible storage area for empty excrement collecting bags. Because of its simple design, any additional bulk added to the leash because of this invention is negligible. Consequently, the leash can be folded and stored as usual; the pet owner need not think of or care for additional gadgets attached to the leash.

Also, because of its simple design, this invention allows the pet owner to remove only the excrement collection bag needed in the ready use position. Once the excrement collecting bag has been used, it can be attached to the invention so that the excrement does not fall out of the excrement collecting bag.

### BRIEF SUMMARY OF THE INVENTION

This invention provides the pet owner with a leash that has a readily accessible storage area for empty excrement collecting bags. Because of its simple design, any additional bulk added to the leash because of this invention is negligible. Consequently, the leash can be folded and stored as usual; the pet owner need not think of or care for additional gadgets attached to the leash.

Additionally, because of its simple design, this invention allows the pet owner to remove only the excrement collection bag needed in a ready use position. Once the excrement collecting bag has been used, it can be attached to the invention so that the excrement does not fall out of the excrement collecting bag.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1 is a plan view of a leash with the invention;

FIG. 2 is a plan view of the invention;

FIG. 3 method for using invention;

FIG. 3a shows how a bag can be folded prior to attaching it to the invention;

FIG. 4. shows a method for attaching a bag with handles to the invention.

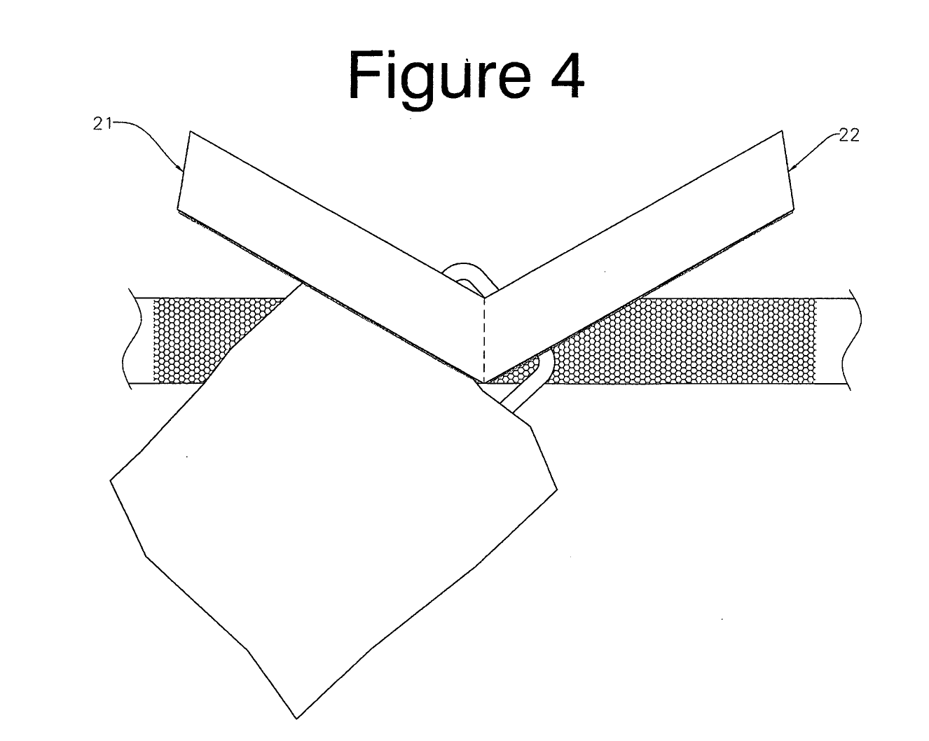

### DETAILED DESCRIPTION OF THE INVENTION

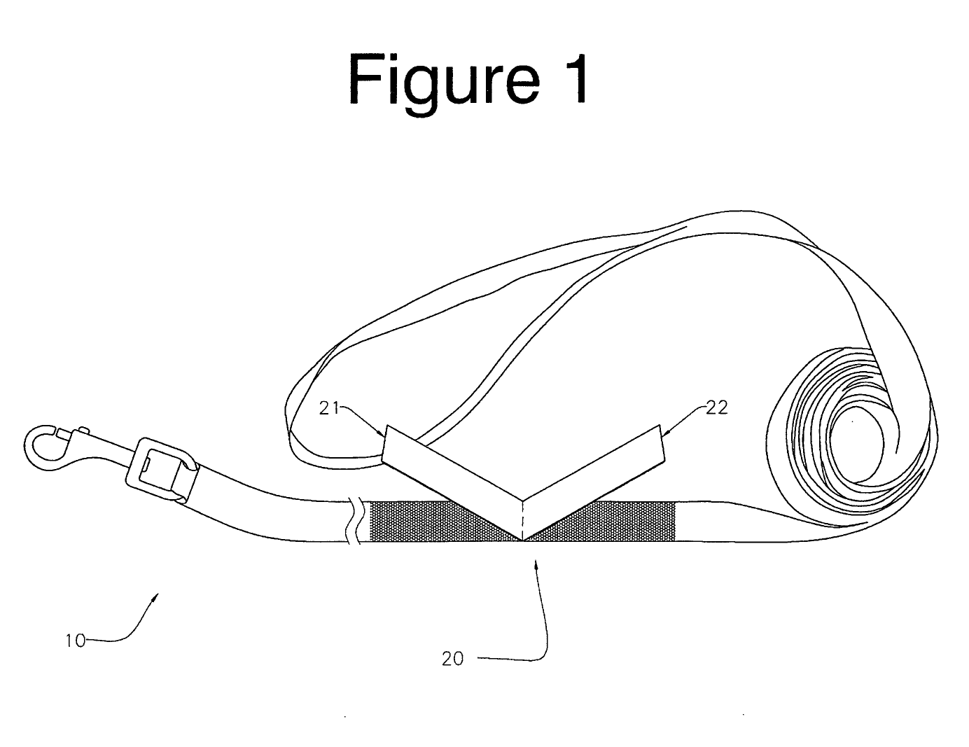

The present invention is directed at a leash that provides a securing device to store empty and used excrement collection bags and methods to use the securing device. As shown in FIG. 1, the leash comprises a standard pet leash 10 and a securing device 20. The securing device 20 is attached along the length of the leash 10. The securing device is a length of sturdy material which is attached to the leash and has at least a first arm and a second arm 21, 22. The arms 21, 22 have a means to temporarily and repeatedly attach to the leash once the excrement bag(s) is in place.

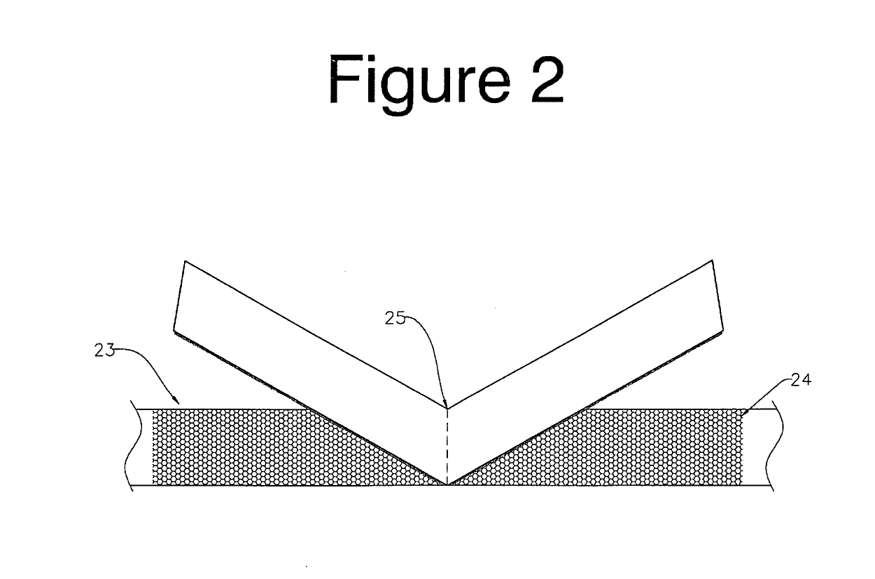

In the preferred embodiment, shown in FIG. 2, the securing device comprises a length of Velcro 23. One side of the Velcro 24, whether the hook or pile side, is completely attached onto a length of leash. The other side of the Velcro is attached to the leash at a focal point 25.

Although the user of the leash can use his ingenuity to determine how best to use the securing device, there are two preferred methods. The first method relates to bags, with or without handles, and other items, such as toys. The second method relates to bags that have handles such as grocery bags.

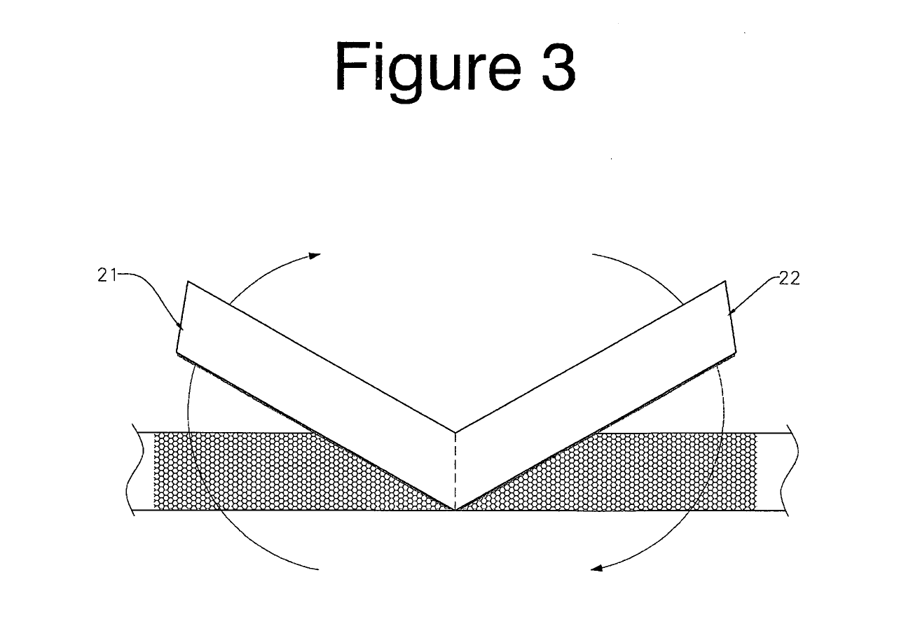

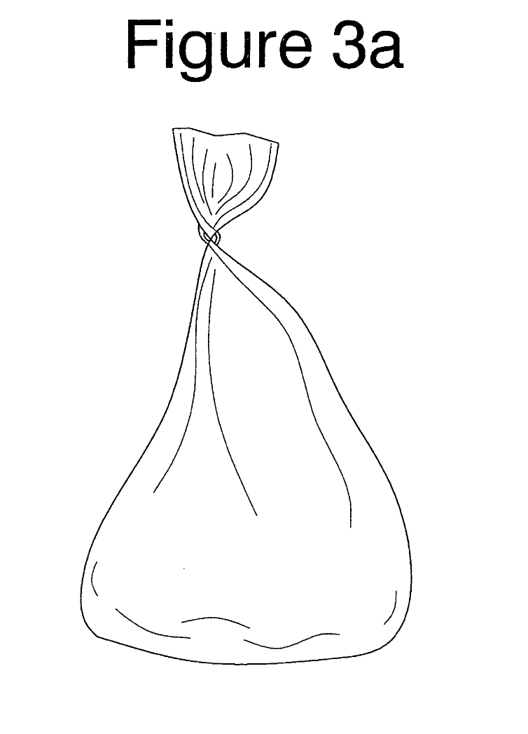

For bags the do and do not have handles a method of use is shown in FIG. 3. The excrement bag is pulled through the leash and the first arm 21,22 of the securing device, over the focal point, and through the leash and the second arm 21, 22 of the securing device. The arms are secured to the leash at a convenient time. To prevent a full bag from loosing its contents, the user can twist the bag opening closed, as shown in FIG. 3a, prior to using the method described above. For bags or other items that have handles, the user can pass the arms 21, 22 of the securing device through the handles and attach the arms 21, 22 of the securing device to the leash.

In view of the above, it will be seen that various aspects and features of the invention are achieved and other results and advantages can be attained. For example, the securing device can also be used to carry toys, keys, wallets, among others. While preferred embodiments of the invention have been shown and described, it will be obvious to those skilled in the art that changes and modification may be made therein without departing from the invention in its broader aspects.

What is claimed:

1. an apparatus for securing empty and/or full excrement waste bags and/or other items to a leash comprising:
a. a length of sturdy material attached to a leash, along the length of the leash, at least one attachment location, creating at least a first arm and a second arm; and
b. a means to temporarily and repeatedly attach said arms to the leash;

2. a method to use the apparatus of claim 1 comprising:
a. pulling at least a end of an empty or full excrement bag through the leash and the first arm of the apparatus;
b. pulling the empty or full excrement bag over the attachment location;
c. pulling the end of the empty or full excrement bag through the leash and the second arm;
d. attaching the first arm and the second arm to the leash;

3. a method to use the apparatus of claim 1 comprising:
a. pulling at least a end of an empty or full excrement bag through the leash and the first arm of the apparatus;
b. attaching the first arm to the leash;
c. pulling the end of the empty or full excrement over the attachment location;
d. pulling the end of the empty or full excrement bag through the leash and the second arm;
e. attaching the second arm to the leash;

4. a method to use the apparatus of claim 1 comprising;
a. pulling at least two arms through a handle of a empty or full excrement bag;
b. attaching the arms to the leash.
